(19) United States
(12) Patent Application Publication
(10) Pub. No.: US 2006/0290919 A1
(43) Pub. Date: Dec. 28, 2006

(54) Method for testing the generation of scattered light by photolithographic imaging devices

(76) Inventors: Andreas Jahnke, Radebeul (DE); Patrick Klingbeil, Dresden (DE); Ralf Ziebold, Radebeul (DE); Lars Voelkel, Dresden (DE); Alberto Lopez-Gomez, Dresden (DE); Thomas Marschner, Dresden (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/360,272

(22) Filed: Feb. 23, 2006

(30) Foreign Application Priority Data
Feb. 28, 2005 (DE) 10 2005 009 018.4

(51) Int. Cl. G01M 11/00

(52) U.S. Cl. 356/124.5

(57) ABSTRACT

A method for testing the generation of scattered light by photolithographic imaging devices is disclosed. In one embodiment, measuring structures that are to be imaged in a photoresist are provided in the vicinity of deliberately structured sections that cause scattered light in the imaging device to be tested, in a photomask. The scattered light which is caused as a function of the configuration of the sections acts on the measurement structures in the photoresist and leads to changes in their CD, which is measured in the photoresist, and allows conclusions to be drawn about the scattered-light behavior of the imaging device. The method is suitable for specifically testing the lens system of the imaging device.

### CROSS-REFERENCE TO RELATED APPLICATIONS

This Utility Patent Application claims priority to German Patent Application No. DE 10 2005 009 018.4, filed on Feb. 28, 2005, which is incorporated herein by reference.

### BACKGROUND

Microelectronic circuits such as DRAM (Dynamic Random Access Memory) cells have structured layers which are arranged on a semiconductor wafer and are composed of different materials, such as metals, dielectrics or semiconductor material. A photolithographic method is frequently used to structure the layers. In this case, a light-sensitive photoresist is applied to the layer to be structured and is subjected in places to light radiation by means of a photomask, which has the structures to be transferred to the layer, and a photolithographic imaging device. In the case of a positive resist, the exposed sections are soluble in a developer solution, while a negative resist has the opposite behavior. The exposed sections are insoluble in the developer solution, while the unexposed sections are soluble. After a development step, the structures in the photoresist are in the form of openings in which the layer to be structured is exposed. After the development step, the structures can be transferred to the layer by means of an etching process.

During the production of structures with increasingly smaller dimensions by photomasks which have a high proportion of sections that transmit light, the scattering of the light on boundary surfaces of the lenses of the projection system in the imaging device, as well as multiple reflections on the lens boundary surfaces, the photomask and the semiconductor wafer, can considerably adversely affect the image contrast of the imaged structures in the photoresist.

If the structures to be imaged by the photomask in the photoresist are arranged in the vicinity of relatively large sections that transmit light in the photomask, then the scattered light which is caused by the sections which transmit light can result in very major CD (Critical Dimension) fluctuations in the structures to be imaged in the photoresist, and these can lead to extremely small or even disappearing process windows for points in the image field. The expression CD fluctuation means a fluctuation in the critical dimension, that is to say in the smallest structure width that can be formed. The yield of integrated electronic modules per semiconductor wafer can be considerably adversely affected by process windows that are too small.

By way of example, in the case of a dense line-and-column grating, the scattered light which is generated by the imaging device can result in the CDs at the edge of the grating differing considerably from the CD in the center of the grating. The discrepancies may be sufficiently large that the grating is imaged outside a specified area so that the electrical characteristics of the transmitted structure result in the microelectronic module having to be scrapped.

The scattered-light behavior of photolithographic imaging devices for transferring structures from the photomask to the semiconductor wafer should be tested for the reasons mentioned above. One method is described by Tae Moon Jeong, et al. in Proc. SPIE vol. 4691, 2002 pp. 1465. In this method, test structures in the form of line-and-column gratings are arranged in a transparent and in an opaque region in the photomask. The test structures which originate from the transparent region of the photomask are imaged with a different CD in the photoresist than those test structures which originate from the opaque region in the photomask. The difference in the CD is used as a measure for the scattered light which is generated in the imaging device.

A further method for testing the scattered-light behavior of imaging devices is disclosed by the test described by Joseph P. Kirk in 533 Proc. SPIE vol. 2197, 1994 pp. 566. During the test, opaque squares with different dimensions in the micrometer range are arranged in a transparent region in the photomask. The squares are imaged in the photoresist using the imaging device to be tested, and with different exposure doses. Since the scattered light becomes broad at long range, the squares in the photoresist disappear as a function of their size and as a function of the exposure dose. This allows the scattered-light, which is generated in the imaging device and becomes broad at long range to be quantified. This method cannot be used for scattered light which becomes broad at short range, in a region below 2 micrometers.

More recent methods, as described by way of example by Hiroki Futatsuya in Proc. SPIE vol. 5377, 2004 pp. 5377-40, take account of the influence of diffracted light on the CD of a test structure. The diffracted light is produced by structures adjacent to the test structure.

The cited methods for testing the scattered-light behavior of imaging devices have the disadvantage that they are carried out, for example as in the case of the test according to Kirk, in conditions which are not representative of the imaging conditions that are used in practice and as occur during production. The test according to Kirk requires exposure doses which are many times higher than those in production-relevant conditions. The scattered-light behavior of imaging devices in conditions which are not representative of production cannot be transferred directly to the scattered-light behavior in production conditions. A further disadvantage of the conventional test methods is that it is impossible to distinguish between different types of scattered light by means of these tests. For example, scattered lights can be produced not only by irregularities in the lens system but also by light which is diffracted on the structures in the photomask that passes through the imaging device to the imaged structures in the semiconductor wafer. A distinction must be drawn between these different types of scattered light in order to assess the lens system of the imaging device.

For these and other reasons, there is a need for the present invention.

### SUMMARY

The present invention provides a method for testing the generation of scattered light by photolithographic imaging devices. In one embodiment, measuring structures that are to be imaged in a photoresist are provided in the vicinity of deliberately structured sections, that cause scattered light in the imaging device to be tested, in a photomask. The scattered light which is caused as a function of the configuration of the sections acts on the measurement structures in the photoresist and leads to changes in their CD, which is measured in the photoresist, and allows conclusions to be drawn about the scattered-light behavior of the imaging device. The method is suitable for specifically testing the lens system of the imaging device.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates exemplary embodiments of test structures according to the invention.

FIG. 2 illustrates the dimensions of one test structure according to the invention.

FIG. 3 illustrates an arrangement of test structures according to the invention in a photomask.

FIG. 4 illustrates illumination distributions for carrying out a first embodiment of the method according to the invention.

FIG. 5 illustrates an illustration, in the form of a graph, of the light intensity as a function of the position on the wafer surface.

FIG. 6 illustrates one example of CD variations in a test structure.

FIG. 7 illustrates details from a first and a second photomask for carrying out a second embodiment of the method according to the invention.

FIG. 8 illustrates the functional relationship between the amount of scattered light and the distance from the sections to the measurement structure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention provides a method for testing the generation of scattered light by an imaging device, which can be carried out in production conditions and, or allows assessment of the lens system of the imaging device to be tested. Photomasks can be used for carrying out the method.

In a method for testing the generation of scattered light by a photolithographic imaging device, at least one photomask, which has at least one measurement structure, is provided. According to the invention, sections are provided which are adjacent to the measurement structure and are in each case different, that is to say these sections are designed to be different to one another. One possible way to provide the adjacent sections is for, for example, two sections which are directly adjacent to the measurement structure to be formed in the photomask which has the measurement structure. The sections may have structures or may be unstructured, but at least one of the sections contains structures which diffract light. It is also possible for the light transmission of the sections to vary. One possible way to produce different sections is to form a plurality of identical measurement structures in the photomask, with each of the sections which differ from one another being formed adjacent to them. Another possible way to produce the different sections is to use a double exposure technique. In this case, at least two photomasks are required, with a first photomask having the measurement structure and a second photomask having the sections which are adjacent to the measurement structure.

The imaging device to be tested is used to expose the measurement structure which is provided in the photomask, and each of the adjacent sections. In this case, each measurement structure is imaged by the photomask in the photoresist. According to the invention, scattered light which acts on each of the measurement structures in the photoresist is generated by the adjacent sections as a function of the configuration of the sections. After development of the photoresist, CD measurements are carried out on the measurement structures which have been imaged in the photoresist. This scattered light which is generated in the imaging device as a function of the configuration of each of the sections can be characterized by evaluation of the measured CDs, thus making it possible to assess the scattered light produced by the imaging device and the change in this scattered light over time, or to assess the quality of the lens system of the imaging device.

The form of the measurement structure may differ. In particular, it may have structures which are similar to useful structures, such as contact vias. If, by way of example, the measurement structure is in the form of a line-and-column grating with a grating constant of 150 nanometers, line widths, also referred to as CDs are changed as a function of the configuration of the adjacent sections. The line width change can be caused by various factors. By way of example, the lines from 1 to about 5 at the edge of the grating can have their CDs changed by light which is diffracted on structures in the sections. Scattered light which becomes broad at short range can influence the lines from 1 to about 10 in the grating, while scattered light which becomes broad at long range can influence all of the lines. If there is a transparent section adjacent to the line-and-column grating, then the lines from 1 to about 10 at the edge of the grating may be several times 5 nanometers less than the lines in the center of the grating. Lines in the vicinity of an opaque section with a light transmission of 0% become broader, owing to the lack of scattered light, than lines in the center of the grating, for example in 15 nanometers.

As will be described in more detail in the following text, the method according to the invention can be used not only for testing the intensity and range of the scattered light in the imaging device but also for specifically testing the scattered-light behavior of the lens system in the imaging device. One advantage of the method according to the invention is that the test of the imaging device can be carried in realistic production conditions. This is achieved by the use of measurement structures and adjacent sections in the photomask which are similar to the structures and arrangements of photomasks which are used in production.

A further advantage is that the method according to the invention makes it possible to distinguish between influence of light which is diffracted on adjacent structures and light that is scattered on the lens system, on the CD of the measurement structure in the photoresist. The method according to the invention can easily be integrated in production, for example by providing test structures in the photomasks that are used. This allows continuous monitoring of the scattered-light behavior of imaging devices. This should be useful, since the scattered-light behavior of imaging devices is not constant over time.

In order to allow the method according to the invention to be used for testing the lens system in the imaging device, a plurality of test structures are preferably provided in the photomask. In this case, each of the test structures comprises the measurement structure and each of the sections in the photomask which are adjacent to the measurement structure. Alternatively, it would also be possible to provide a plurality of photomasks, each having one test structure. The test structures are then imaged in the photoresist by the photomask, or by the photomasks, by means of the imaging device to be tested.

In one embodiment of the invention, at least four different test structures are provided in the photomask. In this case, two of the four test structures have unstructured sections adjacent to the measurement structure, with the unstructured sections for one of the two test structures being opaque and with the unstructured sections for a further test structure being transparent. Scattered light is produced by the transparent sections in the imaging device, but does not have diffracted light superimposed on it since there are no structures in those sections. The quantity and range of the scattered light can be determined on the imaged measurement structure, which is preferably in the form of a line-and-column grating, by means of the measured widths of the lines formed in the photoresist. However, other measurement structures can also be used.

A comparison of the line widths of a first measurement structure which is imaged in the photoresist and was located in the vicinity of transparent sections in the photomask with a second measurement structure which has been imaged in the photoresist and was located in the vicinity of opaque sections in the photomask allows the scattered light produced by the imaging device to be calculated.

Structures which diffract light are preferably provided in the sections for two further ones of the four test structures, with the light-diffracting structures for a first test structure of the two test structures being provided as a line-and-column grating, which runs parallel to the dimension (CD) of the measurement structure to be measured, and the light-diffracting structures for a second test structure being provided as a line-and-column grating, which runs at right angles to the dimension (CD) of the measurement structure to be measured, close to the resolution limit of the imaging device. It is also possible to provide light-diffracting structures in the sections with a different orientation with respect to the measurement structure.

The scattered light which is generated by the imaging device depends on the path of the light from the photomask to the semiconductor wafer through the imaging device. The scattering effect of the imaging device also depends, inter alia, on the angles at which the light strikes the lens surfaces and on the illuminated lens surfaces, which may have different scattering efficiencies. The path of the light through the imaging device can be influenced by the arrangement of the structures in the adjacent sections.

By way of example, the grating constant of light-diffracting line-and-column gratings determines the angle at which the light is diffracted. The light is diffracted at right angles to the direction of the lines and columns on the line-and-column grating. If the line-and-column grating in the sections is orientate parallel to the dimension (CD) of the measurement structure to be measured, then diffracted and scattered light will influence the CD of the measurement structure in the photoresist. If the line-and column grating in the sections is oriented at right angles to the measurement structure, then no diffracted light will influence the measurement structure in the photoresist. The light which is diffracted on the line-and-column grating in the sections strikes the lens surfaces from different directions, however, as a function of the orientation of the line-and-column grating. This allows different areas of the lens to be scanned. The scattered light that is produced in this case acts on the CD of the measurement structure in the photoresist and allows conclusions to be drawn about the lens quality of the imaging device.

For example, in the case of a lens system whose scattered light behavior is rotationally symmetrical, the scattered light results in the photoresist which are obtained in the sections for different orientation of the line-and-column grating should not differ from one another. They should correspond to the scattered-light result which is produced from unstructured sections which have a transmission of 50%, provided that the line-and-column grating has a coverage level of 50% in those sections. In this case, the influence the diffracted light has on the CD of the measurement structure in the photoresist can be calculated, and can be appropriately taken into account.

The test can be calibrated by means of floodlighting, and can be used particularly advantageously for assessment of lens systems in the imaging devices.

In the case of a second embodiment of the method according to the invention, the measurement structure is provided in a first photomask. Each of those sections which are adjacent to the measurement structure and of which at least one contains structures which diffract light, are provided in a second photomask. Each of the measurement structures is imaged by the first photomask in the photoresist. Each of the sections are imaged by the second photomask in the photoresist by means of the imaging device to be tested. A latent image of the respective measurement structure in the photoresist can be used to adjust the sections with respect to the measurement structure. The expression a latent image means those tracks which an exposed section leaves behind it in the photoresist before the development of the photoresist.

Each of the sections in the second photomask are preferably imaged in such a way that each of the sections which are imaged in the photoresist are at different distances from the measurement structures in the photoresist. This embodiment of the method according to the invention is particularly suitable to quantify the range and the intensity of scattered light. The method also has the advantage that both the measurement structure and the imaging conditions can be provided in a manner which is realistic of production.

In order to carry out the second embodiment of the method according to the invention as described above, the measurement structure in the first photomask is preferably in the form of an isolated structure. The sections to be exposed are formed in the second photomask by means of an opaque region, which is surrounded by the transparent frame, in the second photomask. The opaque region shadows the measurement structure in the photoresist and preferably has a rectangular shape whose dimensions can be varied. The range of the scattered light which is generated by the imaging device can be determined by varying the size of the opaque region. By way of example, if the opaque region is very large, only scattered light which becomes broad at long range can influence the measurement structure in the photoresist.

The measurement structure in the first photomask is advantageously in the form of a line. The width of the line varies as a function of the generated scattered light, and the advantage of this is that it can be measured particularly easily. The greater the amount of scattered light that acts on the line in the photoresist, the narrower the line becomes in the photoresist. However, other forms, for example the contact via form, are also feasible for the measurement structure.

The measurement structure in the first photomask is advantageously surrounded by adjacent filling structures. The filling structures may, for example, be in the form of opaque rectangular spots in the first photomask. However, other forms are also possible.

The distance between the filling structure and the measurement structure can be matched to the particular requirements. The filling structures have the object of matching the measurement structure in the first photomask to the conditions that occur in production.

The photomasks which have already been described above for carrying out the first embodiment of the method according to the invention are also claimed once again in claims 21 to 33.

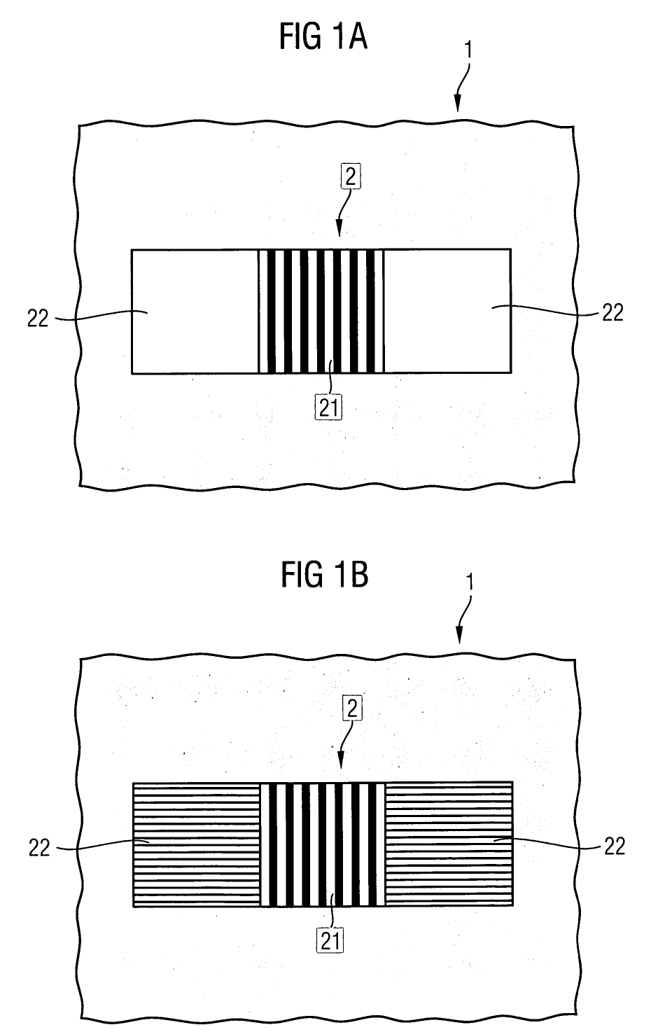

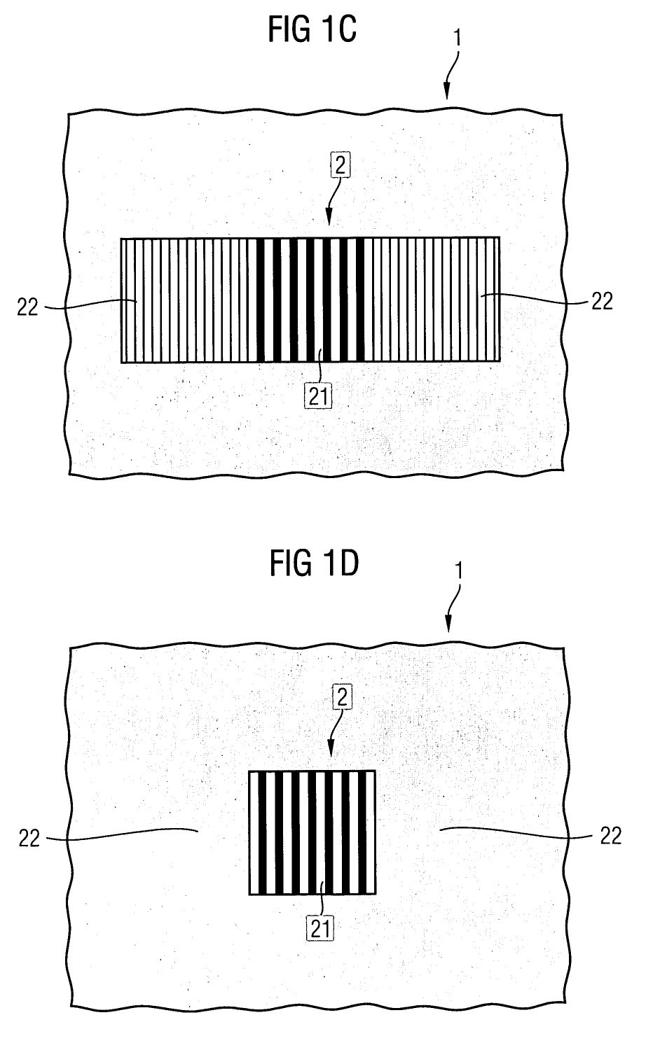

FIG. 1 illustrates details from photomasks 1 in which test structures 2 are provided which can be used to carry out a first embodiment of the method according to the invention.

The detail from the photomask 1 with the test structure 2 can be seen in FIG. 1a. The test structure 2 has a measurement structure 21 and sections 22 which are adjacent to the measurement structure 21. The sections 22, in this case illustrated in white, are provided in a transparent form. The transparent sections 22 allow the scattered light which acts on the measurement structure 21 in the photoresist to be produced in the imaging device. As can be seen from FIG. 1a, the measurement structure 21 is in the form of a line-and-column grating. The scattered light which is generated by the transparent sections 22 in the imaging device acts on the line-and-column grating which is imaged in the photoresist in such a way that the lines towards the edge of the measurement structure 21 are formed with a lower CD in the photoresist. The CD discrepancy between the lines in the center of the measurement structure 21 and lines at the edge of the measurement structure 21 can be used as a measure of the range of the scattered light.

FIG. 1b illustrates the test structure 2 with structured sections 22. As can be seen, the structuring is the form of a horizontally running line-and-column grating. The line-and-column grating in the sections 22 has a lower grating constant that than of the measurement structure 21. The line-and-column grating in the sections 22 diffracts the light. Since, however, the grating is aligned at right angles to the grating of the measurement structure 21, the scattered light result is not influenced by diffracted light. However, the diffracted light may be scattered on the lens surfaces, so that scattered light once again acts on the measurement structure 21.

FIG. 1c illustrates the test structure with sections 22 which have a line-and-column grating which runs parallel to the grating of the measurement structure 21. The grating constant is in this case the same as that for the grating shown in FIG. 1b. In the case of this grating, the diffracted light affects the formation of the CDs of the measurement structure 21 in the photoresist.

The CDs of the measurement structure 21 which are measured in the photoresist and were obtained after imaging of the test structures 2 illustrated in FIGS. 1b and 1c differ from one another since the diffracted light from a grating which runs parallel to the measurement structure 22 influences the CD of the measurement structure 21. This influence can be calculated and can be used to correct the measurement result. If the lens system is rotationally symmetrical, the measurement results on the two measurement structures 21 should not differ from one another. If the results differ, then it can be assumed that sections of the lenses have different scattering characteristics.

FIG. 1d illustrates the test structure 2 with the measurement structure 22 and the sections 21 which are on the form of opaque regions, in this case illustrated dark, in the photomask 1. Since the sections 22 are opaque, no scattered light caused by the sections will act on this measurement structure 21 in the photoresist. The line-and-column grating in the photoresist will nevertheless not have a homogenous CD since the formation of the line widths is also influenced by scattered light from the center of the measurement structure 21, and by diffraction phenomena. A comparison of the results which were obtained from test structures 2 with opaque and transparent sections 22 makes it possible to deduce the scattered light which is produced by the lens system in the imaging device.

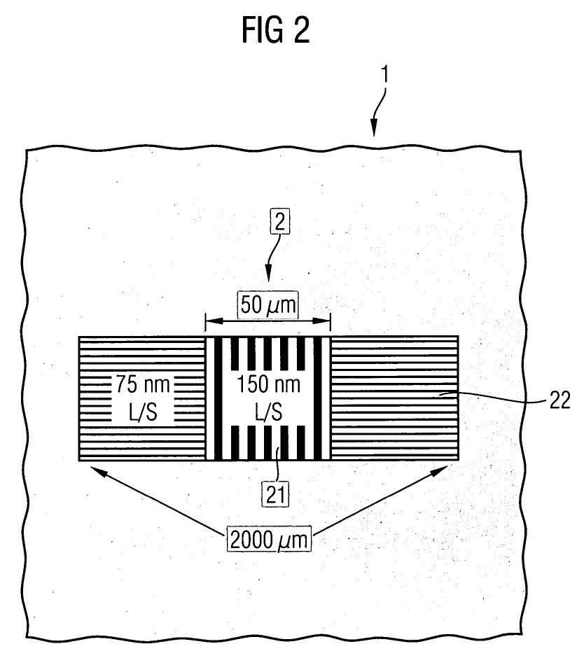

FIG. 2 once again shows a detail from the photomask 1 with one possible embodiment of the test structure 2. The overall length of the test structure 2 in the horizontal direction is 2000 micrometers. The measurement structure 21 occupies 50 micrometers of this length. The measurement structure 21 is in the form of a line-and-column grating with a grating constant of 150 nanometers, and the line-and-column grating in the sections 22 has a grating constant of 75 nanometers. The ratio of the line width to the column width is in each case 1:1. The light transmission in the sections 22 may be 50%.

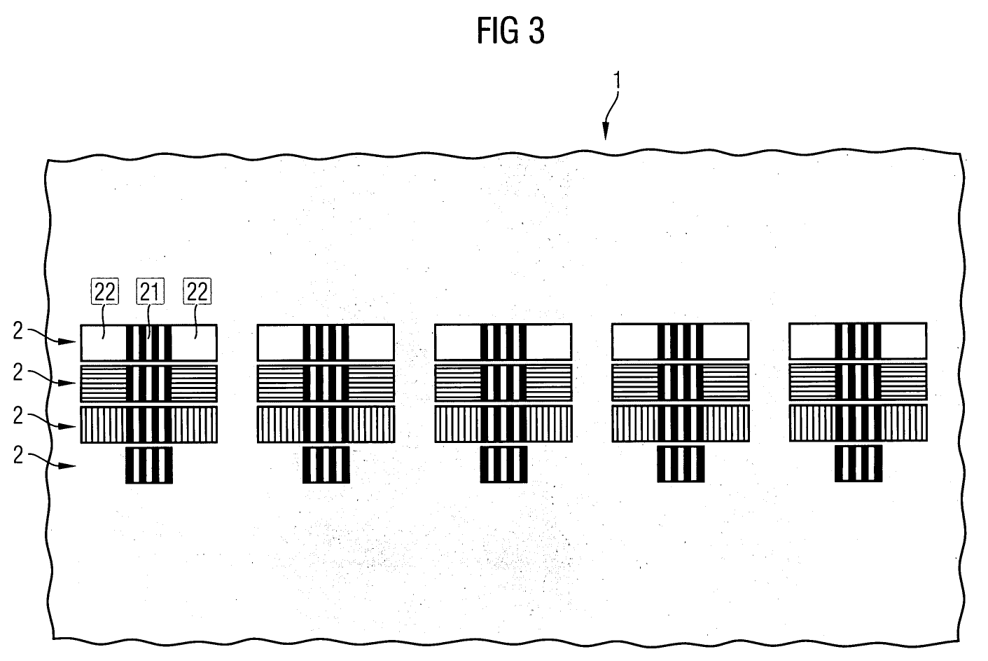

FIG. 3 illustrates an arrangement of test structures in the photomask 1. The illustrations shows four test structures 2 which are arranged one above the other and each differ in the configuration of their adjacent sections 22. These are four test structures 2 as shown in FIG. 1. The arrangement of the four test structures 2 is repeated in the horizontal direction, and is distributed over the exposure slot. This makes it possible to test the scattered light behavior of the imaging device over the entire exposure slot.

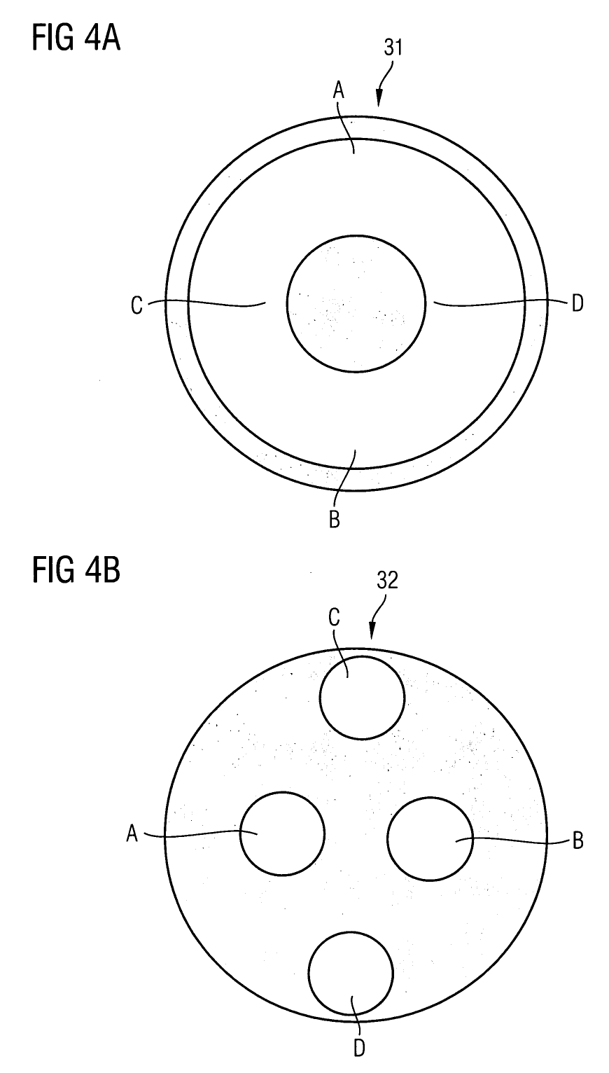

FIG. 4 illustrates a first embodiment of preferred illumination distributions for carrying out the method according to the invention.

FIG. 4a illustrates an annular illumination distribution 31, which can preferably be used when the test structures 2 as shown in FIG. 1a to c are being used. The exposure wavelength may be 193 nanometers, with the numerical aperture of the imaging device being 0.85. The annular illumination distribution can be used particularly advantageously for the test structure 2 as shown in FIG. 1b, in which the line-and-column grating in the sections 22 runs at right angles to the line-and-column grating of the measurement structure 22. The areas AB of the illumination distribution 31, as shown, are suitable for resolution of the line-and-column grating of the sections 22 which, for example, has a grating constant of 75 nanometers. The filling factor σ may be 0.76. The areas CD that are shown are suitable for resolution of the line-and-column grating of the measurement structure 21 with, for example, a grating constant of 150 nanometers. The filling factor σ may be 0.38.

FIG. 4b illustrates a further example of an optimised, dipole-like illumination distribution 32, which comprises two dipoles, that is to say one dipole in the y direction CD and one dipole in the x direction AB. The illumination situation is likewise suitable for exposure of the test structure 2 illustrated in FIG. 1b. The y dipole CD can be used to resolve the 75 nanometer line-and-column grating, which runs at right angles to the line-and-column grating of the measurement structure 2, that is to say horizontally. A value of 0.76 can be provided for σ. The exposure wavelength and the numerical aperture are provided as described in FIG. 4a. The x dipole AB can be used to resolve the 150 nanometer line-and-column grating of the measurement structure 21. A value of 0.38 can be provided for σ.

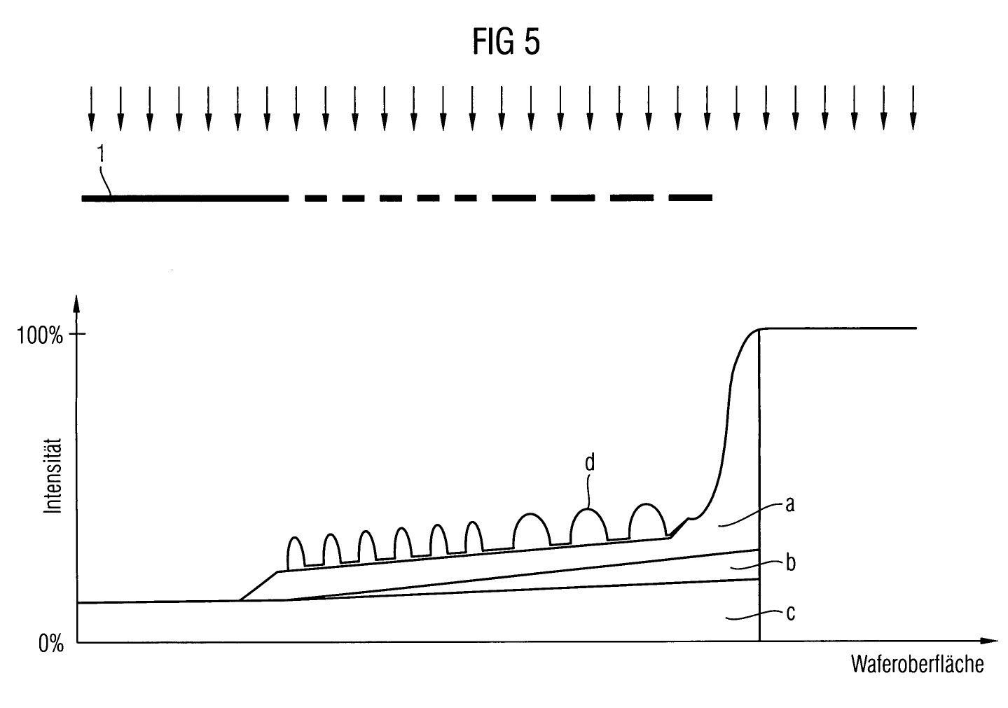

The light intensity above a wafer surface used for exposure of the photomask 1 which has two line-and-column gratings with different grating constants in the vicinity of a transparent region is shown in FIG. 5.

In FIG. 5, the light from the illumination source is indicated by the arrows pointing vertically downwards. The photomask 1 is located underneath the arrows and is illustrated as a dashed line. The transparent regions in the photomask 1 are located where the line is interrupted. Underneath the illustrated photomask 1, the distribution of the light intensity is shown as a function of the position on the wafer surface. As can be seen from the graph, the entire wafer surface is illuminated, although at a low intensity. The illustrated intensity area c is caused by scattered light which becomes broad at long range, while the area b is caused by scattered light that becomes broad at short range, and the area a is caused by diffracted light. The scattered light forms, so to speak, an offset with respect to the actual intensity distribution caused by the structuring in the photomask 1. This intensity distribution is illustrated by the line d.

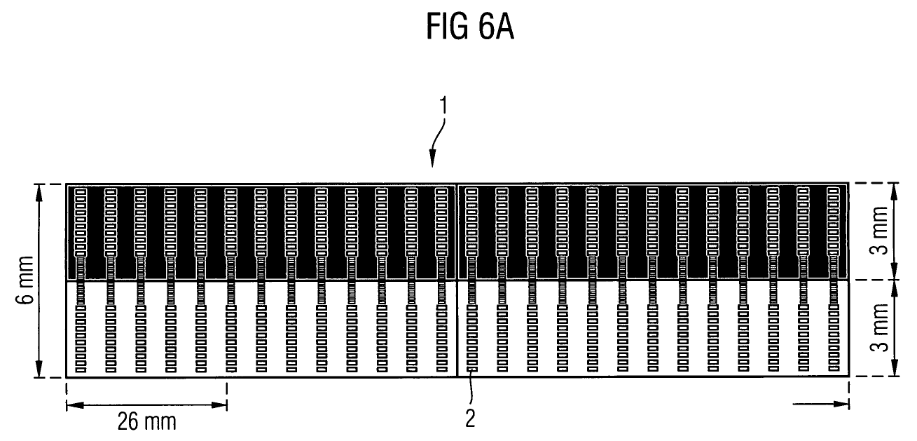

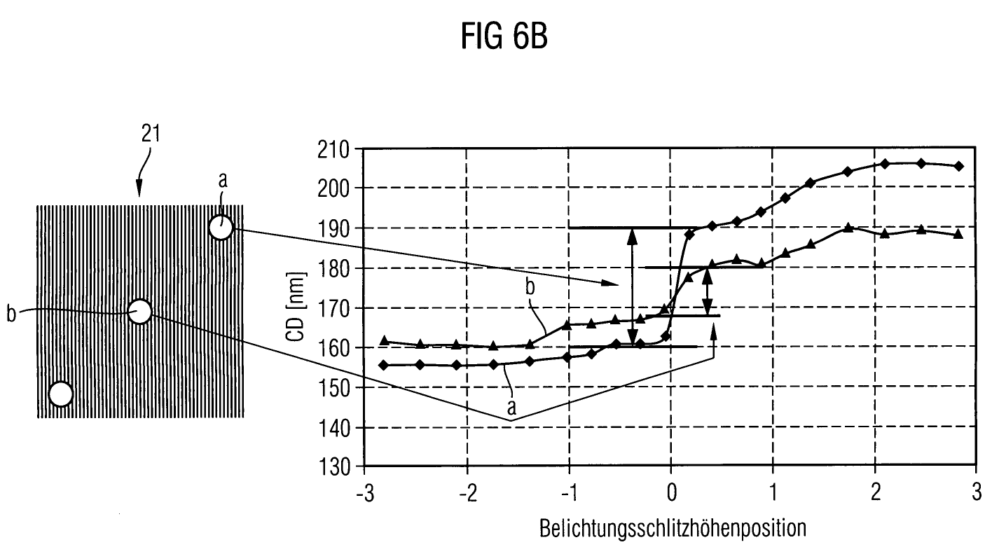

FIG. 6 illustrates one example for the evaluation of a method for testing the scattered light behavior of an imaging device.

FIG. 6a illustrates test structures 2 in a photomask 1 for an exposure slot with a length of 26 mm and a height of 6 mm. The illustrated rectangles correspond to the test structures 2 which are located on the one hand in a transparent area, in this case illustrated white, and an opaque area, in this case illustrated grey.

FIG. 6b illustrates the measurement structure 21 of the test structures 2, for example a 150 nanometer line-and-column grating with dimensions of 60×60 micrometers. The CDs of the imaged measurement structure 2 in the photoresist are measured at the three points shown in the measurement structure 2. The graph that is shown alongside the measurement structure 21 shows the CD in nanometers for the illustrated measurement points a and b as a function of the exposure slot height position, which extends from −3 to +3. The curve a shows the behavior of the CD at the measurement point a. The transition between the transparent and the opaque area of the measurement structures 21 in the photomask 1 as shown in FIG. 6a takes place at the point 0 of the exposure slot height position.

As can be seen from the graph, the CD rises suddenly after the zero crossing. The sudden rise in the CD for the measurement structures 22 which have been measured in the photoresist and were imaged in the photoresist by the opaque region in the photomask 1 was due to the lack of scattered light. The transparent region in the photomask 1 generates scattered light in the imaging device, whose effect is particularly evident at the edge of the measurement structure 21 and leads to a reduction of the CD in the photoresist for the measurement structures 21 which are imaged in the photoresist from the transparent region of the photomask 1. The difference in the CD between the measurement structures 21 in the photoresist which originate from the transparent region and the opaque region in the photomask 1 is a measure of the scattered light which is produced by the imaging device. The scattered light level at the measurement point a at the edge of the measurement structure 21 is 4%, as is indicated by the long double-headed arrow in the graph in FIG. 6b. The curve b shown in the graph was determined at the measurement point b. The measurement point b is located at the center of the measurement point 21 and, as can be seen from the curve b, the scattered light at that point has very much less influence on the formation of the CD. The CD difference between the transparent region and the opaque region is considerably less, as is indicated by the short double-headed arrow on the graph. This results in a scattered light level of 1.5%.

The method according to the invention for testing the scattered light from the imaging device can be evaluated in a similar manner.

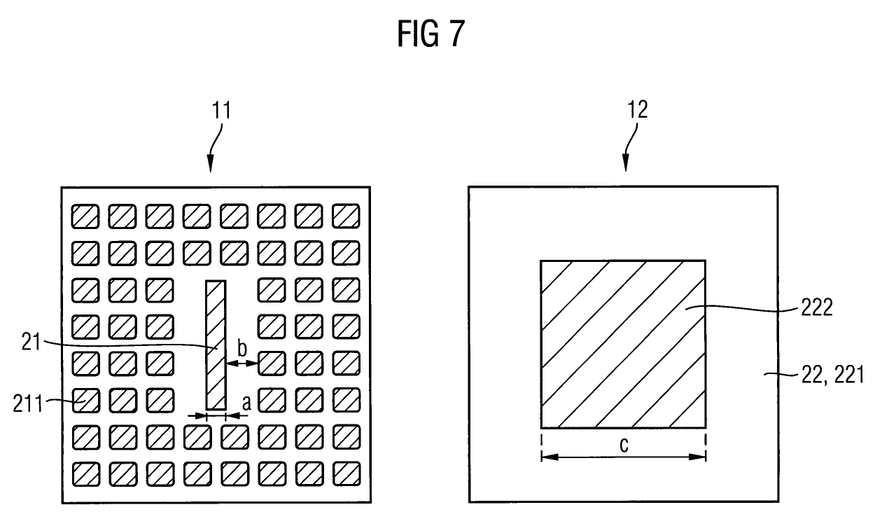

FIG. 7 illustrates a first and a second photomask 11, 12 for carrying out the second embodiment of the method according to the invention.

FIG. 7 illustrates a detail of the first photomask 11 with the measurement structure 21. The measurement structure 21 is in the form of a line which can be imaged in the photoresist. The line can be provided with various widths a. The illustrated filling structures 221 are provided in the vicinity of the measurement structure 21. The object of the filling structures 221 is to make the measurement structure 21 more representative of the actual production conditions. In FIG. 7, white areas correspond to transparent regions in the photomasks 11 and 12, and shaded areas correspond to opaque regions. The illustrated detail from the second photomask 12 contains an opaque region 222 and the sections 22, which are in the form of a transparent frame 221.

In the case of the second embodiment of the method according to the invention, the measurement structure 21 and the filling structures 221 are imaged in the photoresist by the first photomask 11 by means of the imaging device to be tested. A second exposure is then produced using the second photomask 12 by means of the scattered light in the imaging device. A latent image of the measurement structure 21 in the photoresist is used to adjust the second photomask 12 with respect to the first photomask 11. The opaque region 222 in the second photomask 12 covers the measurement structure 21 in the photoresist. The transparent frame 221 causes the scattered light in the imaging device. The larger the opaque region 22, which has the diameter c as shown in FIG. 7, the less the amount of scattered light that will act on the measurement structure 21 in the photoresist.

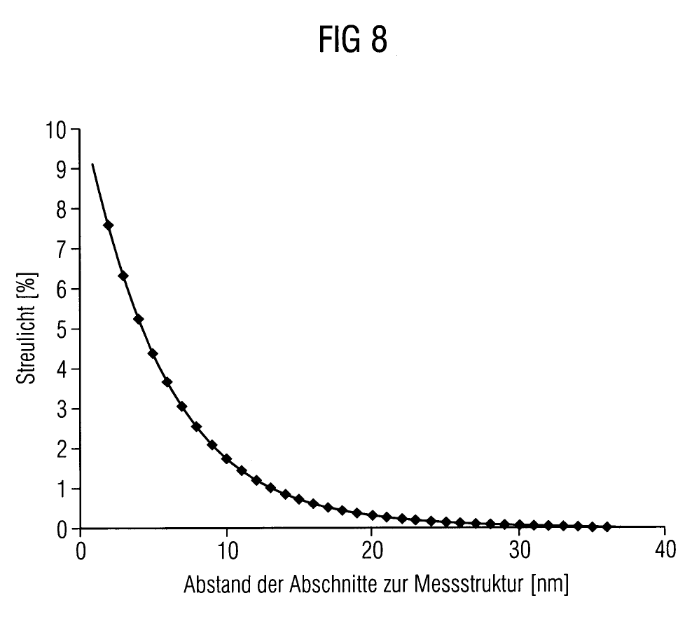

FIG. 8 illustrates the functional relationship between the scattered light as a percentage and the distance between the sections 22 by means of which the scattered light is generated, with respect to the measurement structure 22, in nanometers. The distance between the sections 22 is varied by varying the diameter c of the opaque region 222 in the second photomask 12. The distance is in the form (c-a)/2. The scattered light is given, as a percentage, by the following formula:

$$scattered light ( \% ) = \frac{{CD}_{without second exposure} - {CD}_{withsecondexposure}}{Gradient \times {dose}_{second exposure}}$$

In this case, the expression gradient means the relationship between the CD and the exposure dose.

As can be seen from the curve illustrated in FIG. 8, the scattered light which acts on the measurement structure 21 decreases, as expected, as the distance of the transparent sections 22 which cause the scattered light increases. The range of the scattered light which is generated by an imaging device can be determined in a realistic manner by means of the second embodiment of the method according to the invention. The curve which is illustrated in FIG. 8 and is calculated using the method helps to precisely specify the influence of the scattered light on productive structures for a given imaging device. The method can also be used to characterize asymmetric offsets on the imaging device, by shifting the opaque region in the second photomask 12, and by adjusting it asymmetrically with respect to the measurement structure 21, for the second exposure.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for testing the generation of scattered light by a photolithographic imaging device comprising:
providing at least one photomask, which has at least one measurement structure;
providing sections which are adjacent to the measurement structure, with the respectively adjacent sections being designed differently, and at least one section containing structures which diffract light;
exposing each of the measurement structures that are provided in the photomask and of each of the adjacent sections, with each of the measurements structures being imaged by the photomask into the photoresist, and scattered light which acts through the adjacent sections onto each of the measurement structures in the photoresist being generated as a function of the configuration of the sections;
conducting CD measurements on each of the measurement structures which are imaged in the photoresist; and
evaluating the measured CDs, characterizing the scattered light which is generated in the imaging device as a function of the configuration of each of the sections, and assessment of the imaging device.

2. The method as claimed in claim 1, comprising providing the photomask with a plurality of test structures, or photomasks are each provided with at least one test structure, with each of the test structures having the measurement structure and having those sections in the photomask which are each adjacent to the measurement structure; and
imaging the test structures in the photoresist by the photomask, or by the photomasks, by means of the imaging device to be tested.

3. The method as claimed in claim 1, comprising designing the sections are designed to have different light transmission or structuring.

4. The method as claimed in claim 2, comprising providing the photomask with at least four different test structures, or four photomasks are each provided with one test structure; and
imaging the test structures by the photomask or the photomasks in the photoresist, by means of the imaging device to be tested.

5. The method as claimed in one of claim 1, comprising wherein the measurement structure in the photomask is in the form of a line-and-column grating which is to be imaged in the photoresist.

6. The method as claimed in claim 4, comprising wherein the sections of two of the four test structures are unstructured.

7. The method as claimed in claim 6, comprising wherein the unstructured sections of one of the two test structures are transparent.

8. The method as claimed in claim 6, comprising wherein the unstructured sections of one of the two test structures are opaque.

9. The method as claimed in one of claim 5, comprising wherein structures which diffract light are provided in the sections of two of the four test structures.

10. The method as claimed in claim 9, comprising wherein structures which diffract light are in the form of a line-and-column grating, which runs parallel to the measurement structure, in one of the two test structures.

11. The method as claimed in claim 9, comprising wherein structures which diffract light are in the form of a line-and-column grating, which runs at right angles to the measurement structure, in one of the two test structures.

12. A method for testing the generation of scattered light by a lens system in an imaging device, using a method as claimed in claim 1.

13. The method as claimed in claim 1, wherein a first photomask with the measurement structure is provided;
providing each of the sections adjacent to the measurement structure in a second photomask;
imaging each of the measurement structures by the first photomask in the photoresist; and
imaging each of the sections by the second photomask in the photoresist by means of the imaging device to be tested, with a latent image of each of the measurement structures in the photoresist being used to adjust the sections with respect to the measurement structure.

14. The method as claimed in claim 13, wherein each of the sections in the second photomask is designed in such a manner that each of the sections which are imaged in the photoresist are different distances from the measurement structure in the photoresist.

15. A photomask set comprising:
a first and a second photomask for testing the generation of scattered light by a photolithographic imaging device; and
a measurement structure in the form of an isolated structure is formed in the first photomask and is surrounded by adjacent filling structures and sections to be exposed in the second photomask are formed in the second photomask by means of an opaque region, which is surrounded by a transparent frame and covers the measurement structure in the photoresist.

16. The photomask set as claimed in claim 15, comprising wherein the measurement structure in the first photomask is in the form of a line.

17. The photomask set as claimed in claim 15, comprising wherein the opaque region and the transparent frame in the second photomask are rectangular.

18. The photomask set as claimed in claim 15, comprising wherein the opaque region is provided with different dimensions.

19. The photomask set of claim 15, comprising wherein the filling structures are in the form of opaque rectangular spots in the first photomask.

20. The photomask set of claim 19, comprising wherein the spots are at a predetermined distance from the measurement structure.

21. A photomask for carrying out the method as claimed in one of claim 2, comprising wherein:
the photomask has the test structures, with each of the test structures having the measurement structure, which is in the form of a line-and-column grating, and the sections which are adjacent to each of the measurement structures, and structures which diffract light being formed as a line-and-column grating, which runs at right angles to the line-and-column grating of the measurement structure, in at least one section.

22. The photomask as claimed in claim 21, comprising wherein the line-and-column grating is provided with a grating constant in the range from 90 to 250 nanometers.

23. The photomask as claimed in claim 21, comprising wherein the photomask has at least four test structures.

24. The photomask as claimed in claim 21, comprising wherein the light transmission and structuring of the sections are different.

25. The photomask as claimed in claim 23, comprising wherein the sections for one of the four test structures are unstructured and transparent.

26. The photomask as claimed in claim 23, comprising wherein the sections for one of the four test structures are unstructured and opaque.

27. The photomask as claimed in claims 24, comprising wherein structures which diffract light are provided in the sections for two of four test structures.

28. The photomask as claimed in claim 27, comprising wherein the structures which diffract light are in the form of a line-and-column grating which runs parallel to the line-and-column grating of the measurement structure for one of the two test structures.

29. The photomask as claimed in claim 27, comprising wherein the structures which diffract light are in the form of a line-and-column grating which runs at right angles to the line-and-column grating of the measurement structure for one of the two test structures.

30. The photomask as claimed in claim 28, comprising wherein the line-and-column grating of the sections is provided with a grating constant in the range from 50 to 90 nanometers.

31. The photomask as claimed in claim 27, comprising wherein the sections have a light transmission in the range from 30 to 70 percent.

32. The photomask as claimed in claim 28, comprising wherein
the ratio of the line width to the gap width in the line-and-column grating of the sections 22 is 1 to 1; and
the light transmission of the sections is 50 percent.

33. The photomask as claimed in one of claims 21, comprising wherein
the photomask has an arrangement of in each case four differently arranged test structures distributed over the exposure slot, with each of the test structures having a measurement structure in the form of a line-and-column grating and having sections adjacent to the measurement structures, with the sections of the in each case four test structures which are arranged one above the other for each of the first test structures being transparent, and with the sections for each of the second test structures containing line-and-column gratings which run parallel to the measurement structure, and with the sections for each of the third test structures containing line-and-column gratings which run at right angles to the measurement structure, and with the sections for each of the fourth test structures being opaque.

34. A method for testing the generation of scattered light by a photolithographic imaging device comprising:
providing at least one photomask, which has at least one measurement structure;
providing sections which are adjacent to the measurement structure, with the respectively adjacent sections being designed differently, and at least one section containing structures which diffract light;
means for exposing each of the measurement structures that are provided in the photomask and of each of the adjacent sections, with each of the measurements structures being imaged by the photomask into the photoresist, and scattered light which acts through the adjacent sections onto each of the measurement structures in the photoresist being generated as a function of the configuration of the sections;
means for conducting CD measurements on each of the measurement structures which are imaged in the photoresist; and
evaluating the measured CDs, characterizing the scattered light which is generated in the imaging device as a function of the configuration of each of the sections, and assessment of the imaging device.
